(19) United States
(12) Patent Application Publication
(10) Pub. No.: US 2007/0055394 A1
(43) Pub. Date: Mar. 8, 2007

(54) Method and system for efficiently transmitting power when acoustically irradiating rooms

(75) Inventors: Thomas Klotz, Pullach (DE); Robert Eiblmeier, Munich (DE)

Correspondence Address: Horst M. Kasper, 13 Forest Drive, Warren, NJ, 07059, US

(73) Assignee: KLOTZ DIGITAL AG, Haar (DE)

(21) Appl. No.: 10/570,373

(22) PCT Filed: Aug. 30, 2004
(86) PCT No.: PCT/DE04/01912

§ 371 Date: Nov. 3, 2006

(30) Foreign Application Priority Data
Aug. 30, 2003 (DE) 103 40 104.0

(51) Int. Cl. G06F 17/00

(52) U.S. Cl. 700/94

(57) ABSTRACT

The Invention relates to a method for effectively transmitting power and signals to an acoustic irradiation system (1), with which a number of groups of people at different locations receive information. To this end, data in digital form, together with the power supply, are led to at least one digital amplifier module (3) via a common bus (5). The power supply of the modules is designed such that the effective power (Peff) can be uniformly transmitted. Required power peaks are covered by energy buffers of the amplifier module.

The present Invention is concerned with a method for the efficient transmission of the power in connection with the acoustic irradiation of rooms and areas, in particular with a data bus, wherein the data bus enables the uniform transmission of the effective power and therewith optimally employs the transmission cable.

Such information systems are known from the printed patent document WO 03/013041 A2 in the state-of-the-art and serve the purpose to supply a plurality of persons with information, wherein the information is destined only for certain groups of persons. A further known information system in the state-of-the-art is known from the U.S. Pat. No. 5,406,634 in the state-of-the-art. This known information system contains a so-called intelligent loudspeaker unit, which is controlled with the digital data. The intelligent loudspeaker unit exhibits a digital signal processor (DSP), wherein the digital signal processor processes the audio data in congruence with the control data. Thereupon the digital audio data are converted into analog signals with the aid of a digital analog converter, are amplified analogously and are fed to the loudspeaker. The digital audio data are fed to a data bus with the aid of a time multiplexer. Here specific information data destined for a digital audio channel are assigned to each digital audio channel, such that each loudspeaker unit can select its specific assigned information from the plurality of the overall data flow. This so-called intelligent loudspeaker unit exhibits in addition a mixer, wherein the mixer mixes the selected audio channels with each other.

It is felt to be disadvantageous in connection with this pre-known method and the electronics therefore required that the electronics requires a substantial space and exhibits a high weight. Frequently these apparatuses are concentrated in a small chamber, whereby a high thermal load results. As a consequence of the situation the electronics has to be placed in most cases far away from the proper loudspeaker, whereby long line paths result between the control and power electronics and the loudspeaker.

In order to decrease the power losses over long distances between the amplifier and the loudspeaker in such plants, the audio signals at the amplifier output are initially transformed to a higher voltage by transformers according to the known state-of-the-art and are brought again to the original voltage level also at the loudspeaker by way of transformers, which leads to the situation that each loudspeaker unit requires its own transformer.

If such plants are employed in safety relevant areas, for example for evacuation procedures from publicly accessible chambers, then additional breakdown systems are necessary in order to bridge a possible failure of the central power or control electronics and the therefrom resulting failure of complete loudspeaker groups. For this purpose parallel signal paths with proper power and control electronics are installed, which are separated from the power and control electronics, which are installed for standard operation and which possibly can be switched to the breakdown path by way of relays. This method and the therefore required electrical installations are on the one hand expensive and on the other hand technically cost intensive. One of the decisive disadvantages, which are common to all known methods and plants, are the relatively high expenditure in energy, which is frequently the cause of uncontrollable interferences.

Therefore it is an object of the present Invention to operate rooms or, respectively, regions with optimum loudness and best sound quality while a uniform power transmission occurs.

This object is resolved with the characterizing features of the main claims.

The Invention method for efficient transmission of the effective power at least one loudspeaker of a sound irradiation system comprises that a special data bus is employed, wherein the data bus uniformly transfers the effective power (P eff) also in case of a high crest factor (c) of the signal data together with the digital data, wherein the corresponding amplifier module is disposed immediately at the loudspeaker.

A public address system constructed according to the present Invention method with at least one loudspeaker and at least one power amplifier and a master unit is characterized in that the bus uniformly transfers both the digital data as well as also the effective power for supplying the power amplifier, wherein the digital power amplifier is disposed in a module immediately at the loudspeaker.

Here it is advantageous that a dynamic power adaptation is performed, and wherein the effective power is led over the digital data bus with a commercial feed cable.

In addition it is advantageous that the dynamic peak powers are caught directly in the amplifier module by way of an energy buffer.

A further advantage comprises that a support capacitor is employed as an energy buffer wherein the energy buffer is discharged in case of increased signal peaks and wherein the energy buffer is charged again at a lesser signal level.

It is also advantageous that a digital power amplifier is employed with increased efficient power capability.

The employment of a commercial standard cable, for example of a CAT5 cable with an RJ 45 plug, is advantageous, wherein the wire cross-section for example amounts to 0.2 square millimeters for each wire.

It is furthermore advantageous that the signal flow up to the loudspeaker is monitored.

It is furthermore advantageous that an amplifier module feeds at least one loudspeaker.

A particularly advantageous situation represents the employment of the amplifier module at signals with relatively high crest factor, wherein the crest factor is defined as c=Umax/Ueff.

It is further advantageous that the data bus (5) comprises at least two planes or, respectively, layers.

It is advantageous in this connection that at least one layer is covered with the data and power transmission.

It is further advantageous that at least one layer is covered with the arbitration and data protection.

It is further advantageous that at least one layer is covered with the organization of the participants.

It is furthermore advantageous that at least one layer is covered with the audio formation and the command formation.

It is furthermore advantageous that at least one layer is employed as an application layer.

It is also advantageous that the multilayer bus corresponds to the specification of the International Standard Organization (ISO) of a known communication model (OSI), for example RS 485.

The public address system according to the present Invention exhibits advantageously a power amplifier, wherein the power amplifier is operated digitally and/or analog.

It is advantageous in this context that the digital amplifier module exhibits an energy buffer, wherein the energy buffer can be for example a capacitor.

It is advantageous that the data bus represents a linear network and that the data are led both unidirectional as well as bidirectional.

It is also advantageous that the data bus exploits a commercial cable, for example CAT 5.

Furthermore it is advantageous that the data on the bus are sent in at least two blocks, wherein the individual blocks contain header data, control data and audio data.

It is advantageous that the data, in particular the control data, are coded for error recognition.

Furthermore it is advantageous that the data on the bus are coded in such fashion that the DC voltage part of the data signals is low.

Advantageously the bus exhibits a master slave structure, wherein any arbitrary control apparatus can be employed as a master and wherein the above recited amplifier module can be employed as a slave.

It is also advantageous that the modules in the bus are either switched or connected in series or are connected in a T-shaped configuration.

These advantageous embodiment features enable now an optimum power transmission on the basis of an RS 485 interface. RS 485 is the most frequently exploited transmission technology. It employs shielded, twisted two wire lines and enables transmission rates of up to 12 Mbaud.

An electrical signal which is represented as a voltage difference between the conductors of a conductor pair, serves for sending and receiving of binary information. The differential output of the bus participants delivers at least 1.5 volts and a maximum of 5.25 volts. The differential input has a threshold of 0.2 volts. The data bus employs a full duplex transmission, that is a conductor pair for each direction (4-wire cable).

In addition the voltage supply of the connected module is performed through this line. For this purpose a DC voltage of a maximum of 50 volts is disposed between the conductor pair for the data transfer to the modules (TX) and the conductor pair for the data transfer from the modules (RX). Here the TX-conductor pair is placed onto the negative potential (ground) and the RX-conductor pair is placed on the positive potential. The difference voltage for data transmission is modulated onto this DC voltage.

Suitable cables have to have sufficiently low resistance for power transmission as well as they have to assure the transmission of the data signals over a required cable length. The recommended cable is the CAT 5 STP. It has 4 conductor pairs with a wire cross-section of 0.2 square millimeters. In each case two conductors are connected in parallel in the data bus, and therewith two conductor pairs are available for transmission. A conducting cross-section of 0.8 square millimeters is generated for the power transmission. The line has to be terminated at both ends with the characteristic impedance of the cable for minimizing signal reflection. A resistance of 100 ohms is to be selected in case of a cable CAT 5. This resistance has to be connected at each side between TX+ and TX− or, respectively, between RX+ and RX−.

The data bus according to the present Invention transfers also the supply power of the connected modules on a four wire line in addition to the digital audio data and control data in two directions.

The amplifier modules at this bus can be directly operated at the loudspeaker. These amplifier modules offer in addition to a very efficient digital amplifier also an energy buffer for the signal peaks. The effective power can therewith be uniformly transferred to these modules. The energy buffer delivers the increased power during signal peaks and the energy buffer is again charged during the lesser signal levels. One obtains the possibility with this dynamic power adaptation to consider only the effective power in connection with the power feeding through the cable, while the dynamic peak loads are caught directly at the loudspeaker.

Based on the dynamic power adaptation at the loudspeaker one obtains the possibility to adapt an acoustic irradiation plant with regard to power optimally to the employed program signal, which leads to an equivalent power delivery at the loudspeakers.

A system with a one hundred meters data bus is considered in the following. The cable with 4×0.5 square millimeters wire cross-section is employed. A DC voltage of 48 volts with 75 watts is to be fed in, after one hundred meters one obtains a power of 65.5 watts corresponding to the cable losses. Starting from an efficiency factor of the amplifier of 85 percent, there results an effective power at the loudspeaker of 55.7 watts. For example with a typical language voice signal having a crest factor of 13 dB, there can be generated a loudness based on the dynamic power adaptation, which loudness corresponds to a conventional amplifier with 557 watts distortion limited output power immediately at the loudspeaker. In the case of a conventional amplifier and a cable length of one hundred meters with 4×0.5 square millimeters wire cross-section and this loudness and reproductive quality for a conventional one hundred volts acoustic irradiation system can only be achieved with 818 watts distortion limited output power. Here for example transformer losses of the conventional systems have been disregarded.

The following table shows the advantage of the dynamic power adaptation by way of an example with a one hundred meters line with 4×0.5 square millimeters wire cross-section at different programs signals here the power of 75 watts at 48 volts and DC voltage is fed into the UPAT data bus. An efficiency factor of the digital amplifier of 85 percent was assumed for the equivalent power output. The equivalent power corresponds here to the distortion limited output power, which is required by a conventional amplifier directly at the loudspeaker in order to generate the same loudness and reproductive quality. The same cable was the starting point for the amplifier power of a one hundred volts system. The transformer losses at the loudspeaker in the conventional system were here neglected.

| | | | Equivalent Power | Distortion Limited |
|---|---|---|---|---|
| | | | Output of the | Output Power of a |
| | | Power | Amplifier Module | 100 Volts Amplifier |
| | | Fed into | to the Loudspeakers | for Generating of the |
| | | the Cable | after a 100 meter Line | same Loudness and |
| Program | Crest | with 48 | with 4 × 0.5 mm² | Reproductive Quality |
| Signal | Factor | Volts DC | Wire Cross-section | at the same Cable |
| Sinus signal | 3 dB | 75 W | 55.7 W | 57.0 W |
| Pink noise | 6 dB | 75 W | 111 W | 116 W |
| Compressed music | 9 dB | 75 W | 222 W | 245 W |
| typical | | | | |
| Voice typical | 13 dB | 75 W | 557 W | 818 W |
| Measurement | 17.3 dB | 75 W | 1499 W | not possible based |
| signal for | | | | on cable losses |
| dynamic power | | | | |
| according to | | | | |
| EIA/CEA-490-A | | | | |
| Dynamic music | 20 dB | 75 W | 2792 W | not possible based |
| typical | | | | on cable losses |

In case of typical compressed music (9 dB crest factor) an amplifier with 245 watts distortion limited output power has to be employed in conventional systems in order to generate the same loudness and understandability as 75 watts fed into the data bus according to the present Invention.

The difference becomes more clear for signals with higher dynamics. In case of typical language voice a one hundred volts amplifier with 818 watts distortion limited output power is required in comparison with the 75 watts in the case of the data bus according to the present Invention.

In the now following the Invention is illustrated in more detail by way of drawings. There is shown in:

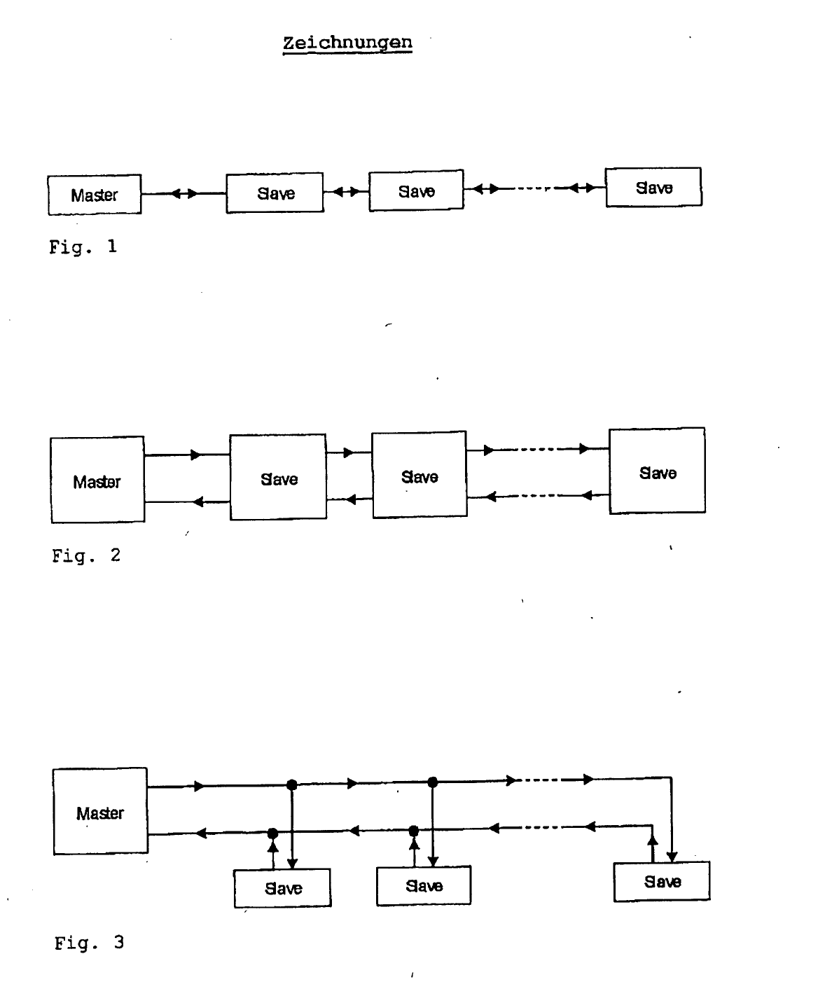

FIG. 1: a principal representation of the invention bus (5) with the master unit (2) and the amplifier modules (3) connected in series;

FIG. 2: a principal representation of the invention bus (5) with the master unit (2) and the amplifier modules (3) connected in series and in bi-directional operation;

FIG. 3: a principal representation of the invention bus (5) with the master unit (2) and the T-shaped connected amplifier modules (3) in unidirectional operation;

The principal representation of the invention bus 5 with the master unit 2 and the amplifier module 3 connected in series is the shown in FIG. 1. The bus has two functional variations: the bi-directional and the unidirectional operation. The audio data are sent also from the modules to the master in bi-directional operation. The data channel is for this reason constantly active. Only the control data are sent back to the master in the unidirectional case, the back channel is only active in case it is required.

FIG. 2 shows the further embodiment example as a principal representation of the bus 5 with the master unit 2 and the amplifier module 3 connected in series under bi-directional operation. Two conductor pairs 6, the forward running and the backward running, pass through the modules 2. The slave units 3 read from the forward running data conductor pair 6,6′, which data conductor pair 6,6′ is written to exclusively by the master 2. The writing is possible for the slave module 3 only to the backward running data conductor pair 6,6′. Here the modules 3 write only upon inquiry by the master 2 (polling). Collisions are thereby avoided. Control data are only written during a limited time upon inquiry, audio data are permanently transferred upon inquiry only until the master 2 this again prevents by way of a concrete instruction. The data not written are passed through.

The physically last module 2 in the bus 5 has to send an empty frame in order to generate a defined data frame and clock cycle for the backward running data conductor pair. Here the control data and the audio data can be written by the last module 3 corresponding to the function of the last module 3. The last module 3 recognizes its position from the fact that no data frame is received on the backward running data conductor pair, then automatically the data frame of the forward running data conductor pair (without control data and without audio data) is switched through.

A further embodiment example as a principal representation of the bus 5 with the master unit 2 and the amplifier modules 3 connected in serious is shown in FIG. 3 in a unidirectional operation. The modules 3 are connected to the two conductor pairs 6,6′ in a T-shaped configuration. The slave units 3 read from the forward running data conductor pair, wherein the forward running data conductor pair is written to exclusively by the master 2. For the slave module 3 writing is only possible onto the backward running data conductor pair 6′. Here the modules 3 write only upon inquiry by the master 2 (polling) in order to avoid collisions.

1. Method for efficient transmission of power to at least one loudspeaker (4) of an acoustic irradiation system (1), by using a special data bus (5), wherein the special data bus (5) transmits the effective power (P eff) also at a high crest factor (c) of the audio signals uniformly together with the digital data, wherein the corresponding amplifier module (3) is disposed directly at the loudspeaker.

2. Method according to claim 1 characterized in that a dynamic power adaptation is furnished, wherein the effective power is led over the digital data bus with a commercial feeder cable (6).

3. Method according to claim 1 characterized in that the dynamic peak hours are intercepted directly in the amplifier module (3) by way of an energy buffer.

4. Method according to claim 1, characterized in that a support capacitor is employed as an energy buffer.

5. Method according to claim 4, characterized in that the energy buffer is discharged at increased signal peaks and is again charged at lesser signal levels.

6. Method according to claim 1, characterized in that a digital power amplifier (3) with increased efficiency of the power capability is employed.

7. Method according to claim 1, characterized in that a commercial standard cable (6), for example a CAT5-cable with an RJ 45 plug, is employed, wherein the wire cross-section amounts to 0.2 square millimeters per wire.

8. Method according to claim 1 characterized in that the signal flow to the loudspeaker (4) is monitored.

9. Method according to claim 1 characterized in that in amplifier module (3) feeds at least one loudspeaker (4).

10. Method according to claim 1, characterized into the amplifier module (3) is employed also at high crest factor of the audio signal, wherein the crest factor is defined as c=Umax/Ueff.

11. Method according to claim 1 characterized in the data bus (5) comprises at least two planes or, respectively, layers, that the individual local loudspeaker units (4) are connected into groups and wherein the loudness of the individual loudspeaker (3) is adapted to the noise level of the environment automatically or remotely controlled.

12. Method according to claim 11 characterized in that at least one layer is covered with the data and power transmission.

13. Method according to claim 11 characterized in that at least one layer is covered with the arbitration and data protection.

14. Method according to claim 11 characterized in that at least one layer is covered with the organization of the participants.

15. Method according to claim 11 characterized in that at least one layer is covered with the audio and command formation.

16. Method according to claim 11 characterized in that at least one layer is employed as an application layer.

17. Method according to claim 1 characterized in that the multi-layer bus (5) corresponds to the specifications of the international standard organization (ISO) of a known communication model (OSI), for example RS 485.

18. Acoustic irradiation system (1) with at least one loudspeaker (4) and at least one power amplifier (3) and the master unit (2), characterized in that the bus (5) uniformly transfers both the digital data as well as also the power, wherein the digital power amplifier (3) is disposed in the module directly at the loudspeaker (4).

19. Acoustic irradiation system according to claim 18 characterized in that the power amplifier (3) is operated digitally and/or analogly.

20. Acoustic irradiation system according to claim 1 the scene characterized in that the digital amplifier module (3) exhibits an energy buffer.

21. Acoustic irradiation system according to claim 20 characterized in that the energy buffer is a capacitor.

22. Acoustic irradiation system according to claim 18 characterized in that the data bus (5) exhibits at least two layers, wherein at least one layer of the at least two layers is covered with the data transmission and the power transmission.

23. Acoustic irradiation system according to claim 1 characterized in that the data bus (5) is a linear network and guides the data both unidirectional as well as also bi-directional.

24. Acoustic irradiation system according to claim 1 characterized in that the data bus (5) uses a commercial cable, for example CAT 5.

25. Acoustic irradiation system according to Claim 1 characterized in that the data on the bus (5) are sent in at least two blocks.

26. Acoustic irradiation system according to claim 25 characterized in that the individual blocks contain header data, control data, and audio data.

27. Acoustic irradiation system according to claim 1 characterized in that the bus (5) exhibits a master slave structure.

28. Acoustic irradiation system according to claim 27 characterized in that the modules (3) are connected in series in the bus (5).

29. Acoustic irradiation system according to claim 27 characterized in that the modules (3) are connected to the bus (5) in the T-shaped configuration.
